(19) United States
(12) Patent Application Publication
(10) Pub. No.: US 2021/0368148 A1
(43) Pub. Date: Nov. 25, 2021

(54) VIRTUAL REALITY PANORAMIC VIDEO STREAM PROJECTION METHOD AND DEVICE

(71) Applicant: KANDAO TECHNOLOGY CO., LTD., Ehenzhen, Guangdong (CN)

(72) Inventors: Rui MA, Shenzhen, Guangdong (CN); Zhiyou MA, Shenzhen, Guangdong (CN)

(21) Appl. No.: 16/640,796

(22) PCT Filed: Dec. 26, 2017
(86) PCT No.: PCT/CN2017/118537

§ 371 Date: Feb. 21, 2020

(30) Foreign Application Priority Data
Aug. 23, 2017 (CN) 201710728421.X

(51) Int. Cl. H04N 9/31; G06F 3/01; G06T 3/00; H04L 29/06

(52) U.S. Cl. CPC H04N 9/3188; G06F 3/013; H04L 65/601; H04L 65/80; G06T 3/0087

(57) ABSTRACT

Embodiments of the present invention relate to a method for projecting a virtual reality panoramic video stream to a user, comprising: dividing a panoramic video stream into multiple spherical subareas; according to user viewing angle information tracked in real time, providing different video qualities for the spherical subareas associated with a user viewing angle and the spherical subareas non-associated with the user viewing angle; and moving user viewing points, thus realizing an optimal video reproduction effect and reducing transmission bandwidth. The present invention further relates to a device for projecting the virtual reality panoramic video stream to the user.

### TECHNICAL FIELD

The present invention relates to the field of virtual reality technologies, in particular to a virtual reality panoramic video stream projection method and device.

### BACKGROUND

Virtual Reality (VR) is a technology which has been applied in video, photography, theaters and game scenes and comprises the cross combination of multiple technologies such as multimedia, human-computer interaction, sensors and a network technology. Virtual reality can create a subjective and freely observable virtual world based on the visual sense, auditory sense and even tactile sense of users, and bring a high degree of immersion and participation sense to users, and is an important development direction in the future of multimedia and online entertainment. The virtual reality technology generally comprises two parts, related hardware and software. Virtual reality hardware comprises, for example, human body trackers and sensors, user input devices, 3D displays, projection systems, head-mounted displays, stereophonic systems, motion capture devices, eye-tracking devices and other interactive devices. Virtual reality software comprises display drivers, data transmission, codec algorithms and other parts required for virtual reality videos and games.

With the improvement of the network access environment represented by fiber-to-the-home and 4G network, a large number of virtual reality panoramic pictures or videos made through panoramic cameras or camcorders have established data communication through network with virtual reality devices such as virtual reality displays, projectors, mobile phones or game consoles, and thus users can experience application of virtual reality video through network in real time. Since the virtual reality video must comprise visual information of all angles around the spherical surface of the users so that the users can watch at any angle, real-time streaming is required to broadcast high-definition video data that consumes a lot of bandwidth and other network resources. In the case that virtual reality video of VR video on demand and VR video live broadcast at current generally is high in resolution and high in bit rate, it is difficult for the network conditions of general users to meet the needs of streaming virtual reality video. On the other hand, the viewing angle of the users at any moment is certainly limited, and it is impossible to view all the images in the spherical surface. The images that they see change only when the users turn heads to watch at other angles, which means images in the other areas are not effective and waste network resources. Therefore, it is necessary to save network resources as much as possible while ensuring the video quality within the user viewing angle. In the prior art, the method of limiting the user viewing angle and using sudden irritating images or sounds to attract the user viewing angle to the image spherical characteristic areas may be adopted so as to reduce the transmission bandwidth. However, there is still a lack of a reliable method and device for reducing the transmission bandwidth while guaranteeing the quality of virtual reality video in the main field of view (FOV).

### SUMMARY

The present invention aims to solve the above-mentioned problems in the prior art, and provides a method and a device which can ensure the quality of user viewing angle video and reduce the transmission bandwidth.

The invention discloses a method for projecting a virtual reality (VR) panoramic video stream. The method is characterized by comprising: dividing the panoramic video stream into multiple spherical subareas in a spherical surface with a user as a sphere center, continuously detecting viewing angle information of the user, determining at least one spherical subarea corresponding to the user viewing angle information in the multiple spherical subareas as a main viewing angle area, defining other spherical subareas except for the main viewing angle area as non-main viewing angle areas, determining user viewing points having a predetermined offset from the sphere center, and based on the user viewing points, performing projection to the main viewing angle area with a first video quality and performing projection to the non-main viewing angle area with a second video quality.

In some embodiments, the first video quality is higher than the second video quality in at least one of resolution and frame rate.

In some embodiments, the multiple spherical subareas comprise 18 spherical subareas.

In some embodiments, the 18 spherical subareas comprise 8 spherical subareas located in a spherical equatorial area, 4 spherical subareas located at 45 degrees north latitude, 4 spherical subareas located at 45 degrees south latitude, and 2 spherical subareas located at the south pole and north pole correspondingly.

In some embodiments, projection to the main viewing angle area and the non-main viewing angle areas comprises one of cubic projection, isometric cube projection, equidistant projection and equilateral projection.

In some embodiments, the predetermined offset is half the spherical radius.

In some embodiments, the panoramic video stream is received through a wired or wireless network.

The present invention further discloses a device for projecting a virtual reality (VR) panoramic video stream. The device is characterized by comprising a sensor, a display, a memory and a processor, wherein the memory stores instructions which can be executed by the processor; a transceiver is configured to receive the virtual reality panoramic video stream through a wired or wireless network; the processor is configured to perform the following actions when the instructions are executed: dividing the panoramic video stream into multiple spherical subareas in a spherical surface with a user as a sphere center, reading the user viewing angle information continuously detected by the sensor, determining at least one spherical subarea corresponding to the user viewing angle information in the multiple spherical subareas as a main viewing angle area, defining other spherical subareas except for the main viewing angle area as non-main viewing angle areas, determining user viewing points having a predetermined offset from the sphere center, and instructing the display to perform projection to the main viewing angle area with the first video quality and perform projection to the non-main viewing angle area with the second video quality based on the user viewing points.

In some embodiments, the first video quality is higher than the second video quality in at least one of resolution and frame rate.

In some embodiments, the multiple spherical subareas comprise 18 spherical subareas.

In some embodiments, the 18 spherical subareas comprise 8 spherical subareas located in a spherical equatorial area, 4 spherical subareas located at 45 degrees south latitude, 4 spherical subareas located at 45 degrees north latitude, and 2 spherical subareas located at the south pole and north pole correspondingly.

In some embodiments, projection of the display to the main viewing angle area and the non-main viewing angle areas comprises one of cubic projection, isometric cube projection, equidistant projection and equilateral projection.

In some embodiments, the predetermined offset is half the spherical radius.

According to the embodiments of the present invention, dynamic stream cutting way is adopted for achieving the optimized video reconstruction effect, thus ensuring the video quality in the user main play viewing angle while reducing the network resources required by video transmission in various application scenes such as VR live broadcast, VR on demand, streaming servers and APP players.

### BRIEF DESCRIPTION OF DRAWINGS

The present invention provides accompanying drawings for further understanding of the disclosed content. The accompanying drawings form a part of the present application, but are only configured to illustrate some nonrestrictive examples embodying the concept of the present invention, rather than to set any limitation.

FIG. 1 is a block diagram of a device for projecting a virtual reality panoramic video stream according to some embodiments of the present invention.

FIG. 2 is a flow diagram of a method for projecting a virtual reality panoramic video stream according to some embodiments of the present invention.

FIG. 3 is a schematic diagram of dividing a virtual reality panoramic video into spherical subareas according to some embodiments of the present invention.

FIG. 4 is a schematic diagram of selecting user viewing points according to some embodiments of the present invention.

### DETAILED DESCRIPTION OF EMBODIMENTS

Various aspects of the illustrative embodiments herein will be described below by using terms commonly used by those skilled in the art to convey the substance of their work to others skilled in the art. However, it is apparent to those skilled in the art that alternative embodiments may be practiced with only some of the various described aspects. For explanatory purposes, specific values, materials and configurations are set forth herein to make the illustrative embodiments easier to understand. Nevertheless, it is apparent to those skilled in the art that alternative embodiments herein may be practiced with specific details being omitted. In other cases, well-known features may be omitted or simplified so that the embodiments herein are easy to understand.

Those skilled in the art should understand that although the terms such as first and second may be used herein to describe various elements, these elements should not be limited by these terms. These terms are only configured to distinguish various elements from each other. For example, a first element may be referred to as a second element, and similarly, a second element may be referred to as a first element without departing from the scope of the present invention. As used herein, the term “and/or” comprises any and all combinations of one or more of the associated listed items. The terms used herein are for the purpose of describing particular embodiments only and are not intended to limit the present invention. As used herein, the singular forms “a” and “the” are intended to comprise the plural forms as well, unless the context clearly indicates other meanings.

Those skilled in the art should further understand that the terms “including” and/or “comprising,” as used herein, specify the presence of stated features, integers, steps, operations, elements and/or components, but do not exclude the presence or addition of one or more of other features, integers, steps, operations, elements, components, and/or combinations thereof.

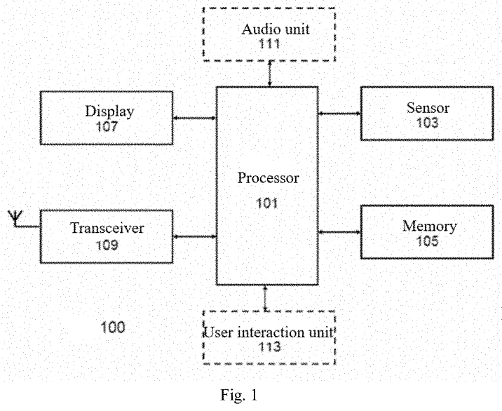

As shown in FIG. 1, a device 100 for projecting a virtual reality panoramic video stream according to some embodiments comprises a processor 101, a sensor 103, a memory 105, a display 107, a transceiver 109, an optional audio unit 111 and a user interaction unit 113.

The processor 101 may be any general-purpose or special-purpose processing device configured to execute instructions, such as a CISC or RISC instruction set processor, an ×86 instruction set processor, a multi-core processor, a single chip microcomputer, a controller, a logic control unit or any other microprocessor or central processing unit (CPU).

The sensor 103 is configured to detect the posture of a user watching virtual reality panoramic video, and continuously transmit the detected user posture to the processor 101 for determination of the user viewing angle information. In a preferred embodiment, the processor 101 and the sensor 103 can continuously communicate in real time or near real time, and determine the user viewing angle information for reduction the sense of delay and improvement of the user experience. The sensor 103 may comprise an eyeball tracking sensor, a head posture sensor, a multi-axis posture sensor, a somatosensory gamepad and the like. For example, CN102946791B and CN102156537B have disclosed methods for detecting the eyeball position and the head posture in the prior art. The sensor 103 can track the direction of the user eyeball or face based on similar technologies so as to determine changes in the viewing angle.

The memory 105 is configured to store machine-executable instructions that can be executed by the processor 101 to play the virtual reality panoramic video described in the embodiments, and may also store received virtual reality panoramic video data for buffering or local playback in some cases. The memory 105 comprises a volatile memory such as, but not limited to, a random access memory (RAM), a dynamic random access memory (DRAM) and a static random access memory (RAM). The memory 105 also comprises a non-volatile memory such as, but not limited to, a CD-read only memory (CDROM), a compact disc, a DVD, a Blu-ray disc, a floppy disk, a magnetic disk, a solid state disk, a read-only memory (ROM), an EPROM, an EEPROM, a flash memory and/or a network storage device. In the cases of VR live broadcast, VR on demand, streaming, APP playback and the like, the memory 105 may also be provided through a remote memory or a cloud. The memory 105 can be specially optimized in response time, read/write speed and other aspects according to the application scenarios of virtual reality.

The display 107 comprises a corresponding special graphic processing unit (GPU) configured to display a virtual reality image and/or an interactive object to a user. The GPU can communicate with the display 107 via an analog or digital interface. The display 107 comprises various existing imaging means such as a television, a flat panel display, a liquid crystal display, a head-mounted display, a projection screen and a media player. In some embodiments, the display 107 may be combined with the audio unit 111. The display 107 may comprise a display interface compatible with the virtual reality panoramic video stream. The display interface comprises, but is not limited to, a high-definition multimedia interface (HDMI), a wireless HDMI, a MHL, a VGA interface, a DVI interface, a mini display port MDP and the like. The display 107 also comprises a corresponding codec for encoding and decoding the virtual reality panoramic video to be played.

The transceiver 109 may be connected to a wireless or wired network so as to provide connectivity to receive a panoramic video stream to be played or vice versa to upload the panoramic video stream. The transceiver 109 may also be configured to receive control instructions and communicate with the processor 101 for remote start-up, shutdown, playback, fast forward or stop operations. In the case of accessing a wired network, the transceiver 109 may comprise a wired network card, a modem, an optical modem and the like so as to access various local area networks, metropolitan area networks, Ethernet or the Internet. In the case of accessing a wireless network, the transceiver 109 may comprise an antenna, a wireless network card, a transmitter, a receiver and the like so as to communicate with servers, base stations, evolved nodes and/or other transceivers according to 4GLTE long-term evolution, Wi-Fi, Bluetooth, wireless local area networks (WLAN), global system for mobile communications (GSM), code division multiple access (CDMA), WCDMA, time division multiplexing (TDM) and the like.

The audio unit 111 is provided when audio information needs to be supplied to a user, and may comprise a loudspeaker, a microphone and the like.

The user interaction unit 113 may be configured to provide a user with a means for interacting with the virtual reality panoramic video, and may comprise an existing device such as a touchpad, a keyboard, a mouse and a game controller. Interaction may also be achieved by detecting the motion of the user hand or body through an additional posture sensor.

In some embodiments, the processor 101, the sensor 103, the memory 105, the display 107, the transceiver 109, the optional audio unit 111 and the user interaction unit 113 may be integrated together to form a system on chip (SOC).

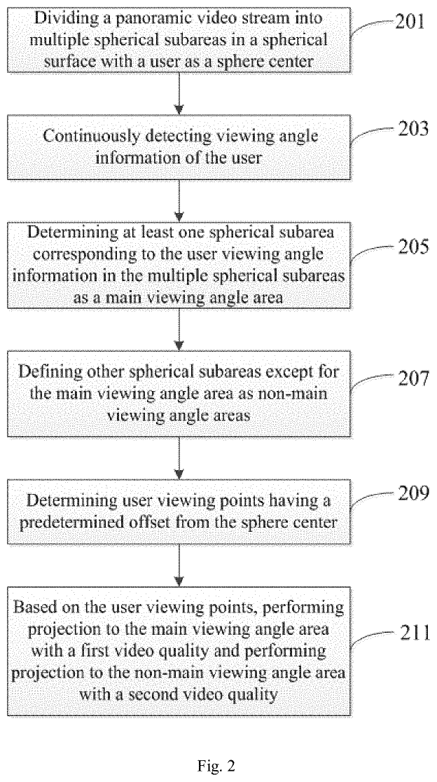

FIG. 2 illustrates a method flow performed by the device 100 according to some embodiments. In step 201, the virtual reality panoramic video is spatially divided at first, namely stream cutting. From the user point of view, images of the virtual reality panoramic video equivalently form a spherical surface centered on a user, which is called a world sphere. The user can freely choose to observe the video anywhere on the spherical surface of the world sphere. According to the human eyeball structure and imaging characteristics, imaging of the user eyeball in the foveal vision is clear, while imaging of the edge area is blurred. Therefore, the spherical areas corresponding to the clear user eyeball imaging areas should be relatively clear in imaging, and the areas where the imaging is blurred or even cannot be observed need not be so clear in imaging. Accordingly, the spherical surface of the world sphere can be divided into multiple spherical subareas, so that different spherical subareas can be projected differently in the subsequent steps.

In step 203, user viewing angle information is continuously detected by the sensor 103 through the above-mentioned various posture detection methods. The user viewing angle information corresponds to spherical areas corresponding to the user viewing direction. The detected viewing angle information is continuously transmitted by the sensor 103 to the processor 101 for processing, so that the processor 101 can determine the user viewing angle in real time or near real time.

In step 205, at least one spherical subarea corresponding to the detected user viewing angle information in the multiple spherical subareas is determined by the processor 101 as the main viewing angle area according to the user viewing angle information, namely the area with higher-quality virtual reality panoramic video images of the user. For the user, the main viewing angle area will appear directly in front of the field of view. The determination of the main viewing angle area will continuously change with the change of the viewing angle of the user.

In step 207, the spherical subareas other than the main viewing angle area at the moment are defined by the processor 101 as non-main viewing angle areas, namely areas with lower-quality virtual reality video images and no influence on the user experience. In an alternative embodiment, only one spherical subarea is determined as the main viewing angle area, and all other spherical subareas are non-main viewing angle areas at this time.

In step 209, projection of the virtual reality panoramic video is further optimized through the processor 101, and a new user viewing point is defined at the point away from the center of the world sphere, namely the original user location at predetermined offset. For the current user viewing angle, through projection based on the user viewing point instead of the original user location, objects viewed by the user in the main viewing angle area closer to the user and directly in front of the user are clearer and higher in resolution, while objects in the non-main viewing angle areas which are located on the two sides and the rear portion away from the user are increasingly blurred and low in resolution. The adjustment method is called eccentric projection. By adopting eccentric projection, the video quality of the user main viewing angle area is improved while the resource consumption of the video stream in the non-main viewing angle area is reduced.

In step 211, the display 107 is further instructed by the processor 101 to project images observed from the user viewing angle onto a projection plane of the corresponding mode in an appropriate projection mode based on the user viewing point, and thus plane projection images are obtained. The display 107 projects the projection images to the main viewing angle area with a first video quality and to the non-main viewing angle areas with a second video quality different from the first video quality. Preferably, the first video quality is higher than the second video quality in at least one of resolution and frame rate. For example, more pixels are distributed at the first video quality in the user main viewing angle area, the resolution (such as 4K) or frame rate (such as 90 Hz) is higher. Fewer pixels are distributed in the non-main user viewing angle areas, and the resolution (such as 1080 P) or frame rate (such as 60 Hz) is lower. Since the number of pixels or frame rate of the non-main user viewing angle is greatly reduced, the overall size of the video stream is also reduced, and the bandwidth required for video stream transmission is also greatly reduced. A proper projection mode at this time comprises, for example, but not limited to, one of cubic projection, isometric cube projection, equidistant projection and equilateral projection. Preferably, compared with cubic projection and other projection modes, resolution distribution in the main viewing angle is more uniform according to the isometric cube projection scheme, therefore, the quality in the main viewing angle area can be stable, and the bandwidth is further reduced.

The user is likely to constantly change the main viewing angle when watching the virtual reality virtual panoramic video. In the case of detecting the change of the user viewing angle information, video streams of the corresponding spherical subareas are dynamically transmitted to the user through the device or method of the embodiments of the present invention. In this way, the effect that the user can watch high-resolution videos all the time can be ensured, and the bandwidth required for transmission is kept low.

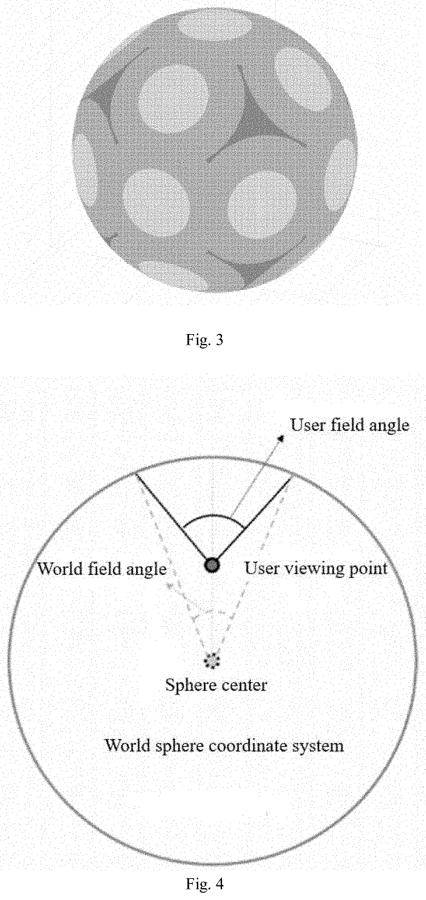

FIG. 3 illustrates an example of cutting a virtual reality panoramic video stream. The original virtual reality panoramic video stream is divided into 18 viewing angles, and when the user plays back, the video is reconstructed nearby in the 18 directions, so that the best video reproduction effect is achieved. The spherical surface of the world sphere is divided by the 18 viewing angles into 8 spherical subareas located in a spherical equatorial area, 8 subareas of which four spherical subareas located at 45 degrees north latitude and four spherical subareas located at 45 degrees south latitude, and 2 spherical subareas located at the south and north poles correspondingly. The bandwidth saving performance, the quality of the videos in the main viewing angle area and the complexity of the algorithm are taken into account through the dividing method. However, it should be noted that the method of dividing the spherical subareas is only an example, and the video stream is not limited to be divided into 18 viewing angles. For example, the spherical subareas can be divided into 4 subareas at the equatorial area, 2 spherical subareas located at 45 degrees north latitude, 2 spherical subareas located at 45 degrees south latitude and 2 spherical subareas located at the south and north poles correspondingly. As another example, the spherical subareas can be further subdivided if resources permit, so that the spherical subareas are divided into 16 subareas at the equatorial area, 8 subareas located at 45 degrees north latitude, 8 subareas located at 45 degrees south latitude, 2 spherical subareas located at the south pole, and 2 spherical subareas located at the north pole. Those skilled in the art can easily think of other divisions from the disclosure of the present invention.

FIG. 4 illustrates selection of eccentric projection predetermined offset and determination of user viewing point according to some embodiments. As shown in the figure, when the position of the user moves from the center of the world sphere coordinate system to the user viewing point with an offset, the viewing angle also changes from the world field viewing angle to the user field viewing angle. Therefore, compared with the world field viewing angle, the video quality of the user main viewing angle area is further improved, and the video stream quality of the non-main viewing angle area is lowered for saving transmission bandwidth. For example, for virtual reality scenes showing different content (such as a distant video showing a macro landscape or a close-up video showing fine details), the amplitude of offset can be adjusted accordingly so that the user can view projection images suitable for the video represent theme. The adjustment of the offset can also be configured to adjust the magnification, especially when the user watches a high-resolution video with a lower resolution device, the playback effect can be optimized by adjusting the offset. For example, when the user watches a 4K, 6K or 8K video on a display 107 with the same resolution of 1080 P, the offset can be adjusted accordingly. In some embodiments, the predetermined offset can be simply selected as half the radius of the world sphere, namely half the distance from the center of the sphere to the spherical surface. However, the offset is not limited to the value and can be freely adjusted or even continuously changed as described above so as to adapt to the specific situation of the user and the video.

Those skilled in the art will understand various other virtual reality video projection devices and/or methods according to the embodiments of the concepts and principles of the present invention when looking at the illustrated drawings and descriptions. All such other devices and/or methods fall within the scope of the disclosure and are within the scope of the concepts and principles of the present invention. In addition, all embodiments disclosed herein can be implemented individually or compositely in any mode and/or in any combination.

What is claimed is:

1. A method for projecting a virtual reality (VR) panoramic video stream, characterized by comprising:
dividing the panoramic video stream into multiple spherical subareas in a spherical surface with a user as a sphere center;
continuously detecting viewing angle information of the user;
determining at least one spherical subarea corresponding to the user viewing angle information in the multiple spherical subareas as a main viewing angle area;
defining other spherical subareas except for the main viewing angle area as non-main viewing angle areas;
determining user viewing points having a predetermined offset from the sphere center; and
based on the user viewing points, performing projection to the main viewing angle area with a first video quality and performing projection to the non-main viewing angle area with a second video quality.

2. The method according to claim 1, characterized in that the first video quality is higher than the second video quality in at least one of resolution and frame rate.

3. The method according to claim 2, characterized in that the multiple spherical subareas comprise 18 spherical subareas.

4. The method according to claim 3, characterized in that the 18 spherical subareas comprise 8 spherical subareas located in a spherical equatorial area, 4 spherical subareas located at 45 degrees south latitude, 4 spherical subareas located at 45 degrees north latitude, and 2 spherical subareas located at the south pole and the north pole correspondingly.

5. The method according to claim 4, characterized in that projection to the main viewing angle area and the non-main viewing angle area comprises one of cubic projection, isometric cube projection, equidistant projection and equilateral projection.

6. The method according to claim 1, characterized in that the predetermined offset is half the spherical radius.

7. The method according to claim 1, characterized in that the panoramic video stream is received through a wired or wireless network.

8. A device for projecting a virtual reality (VR) panoramic video stream, characterized by comprising a sensor, a display, a memory, a transceiver and a processor, wherein the memory stores instructions executable by the processor, the transceiver is configured to receive the virtual reality panoramic video stream through a wired or wireless network, and the processor is configured to perform the following actions when executing the instructions:
dividing the panoramic video stream into multiple spherical subareas in a spherical surface with a user as a sphere center;
reading user viewing angle information continuously detected by the sensor;
determining at least one spherical subarea corresponding to the user viewing angle information in the multiple spherical subareas as a main viewing angle area;
defining other spherical subareas except for the main viewing angle area as non-main viewing angle areas;
determining user viewing points having a predetermined offset from the sphere center; and
based on the user viewing points, instructing the display to perform projection to the main viewing angle area with a first video quality and perform projection to the non-main viewing angle area with a second video quality.

9. The device according to claim 8, characterized in that the first video quality is higher than the second video quality in at least one of resolution and frame rate.

10. The device according to claim 9, characterized in that the multiple spherical subareas comprise 18 spherical subareas.

11. The device according to claim 10, characterized in that the 18 spherical subareas comprise 8 spherical subareas located in a spherical equatorial area, 4 spherical subareas located at 45 degrees south latitude, 4 spherical subareas located at 45 degrees north latitude, and 2 spherical subareas located at the south pole and the north pole correspondingly.

12. The device according to claim 11, characterized in that projection to the main viewing angle area and the non-main viewing angle areas by the display comprises one of cubic projection, isometric cube projection, equidistant projection and equilateral projection.

13. The device according to claim 8, characterized in that the predetermined offset is half the spherical radius.
